(19) United States
(12) Patent Application Publication
(10) Pub. No.: US 2023/0286686 A1
(43) Pub. Date: Sep. 14, 2023

(54) PROTECTIVE FILM FOR CELL PHONES

(71) Applicant: Shenzhen Walkas Technology Co., Ltd., Shenzhen (CN)

(72) Inventor: Qiuhua ZHONG, Shenzhen (CN)

(21) Appl. No.: 17/542,428

(22) Filed: Dec. 5, 2021

(30) Foreign Application Priority Data
Jul. 16, 2021 (CN) 2021216466948

(51) Int. Cl. B65B 33/02

(52) U.S. Cl. CPC B65B 33/02

(57) ABSTRACT

A protective film includes a protective film, a sticking film body, a release film, and a positioning film for positioning with the cell phone from top to bottom sequentially. The bottom edge of the protective film is flush with the bottom edge of the sticking film body and the release film. A protruding portion is formed by extending the middle part of the protective film outward. The protruding portion is provided with a positioning hole, when the protruding portion is folded 90 degrees toward the direction of the sticking film body, the position and the size of the positioning hole are corresponding to the position and the size of the data line interface of the cell phone, and the data line of the cell phone is inserted into the data line interface of the cell phone through the positioning hole for accurately aligning and limiting.

This patent application claims the benefit and priority of Chinese Patent Application No. 202121646694.8 filed on Jul. 16, 2021, the disclosure of which is incorporated by reference herein in its entirety as part of the present application.

### TECHNICAL FIELD

The present disclosure relates to the technical field of electronic device accessories, and more specifically, to a convenient protective film for a cell phone.

### BACKGROUND

Currently, intelligent electronic devices such as cell phones and tablet computers have become the most important communication tools for people, but their screens are easy to be scratched and scratches appear on the screens during using, which affects the display effect and aesthetics of the cell phone screens, or the screens get damaged when the electronic devices accidentally fall. Therefore, people usually stick a transparent plastic or toughened glass film onto the screen of an electronic device to protect the screen from scratching or falling.

The manual film sticking is generally adopted, and the manual film sticking is a technical work with high requirements for film sticking operators. In order to achieve the expected film sticking effects, film sticking operators who are not skilled in the film sticking technology often needs to stick the film for multiple times and repeatedly, which not only leads to the waste of the film sticking of the cell phone, but also delays the film sticking time and increases the film sticking cost.

In order to achieve fast and efficient film sticking, people have invented various film sticking devices, which fix the position of the film sticking by the film sticking device, and precisely align the film sticking device with the electronic devices, so as to accurately stick the film to the surface of the electronic equipment. Although this kind of film sticking device is simple in structure, easy to operate and low in price, it is generally suitable for professional film sticking personnels with the need of sticking a large number of films. For ordinary consumers, the film sticking device increases the use cost, and it is generally almost a disposable product, which is discarded after being used, even if it is stored for use, it will be faced with embarrassing situations such as being unable to find and model mismatching in the next time of use.

Later, people began to make modifications for sticking films, so as to realize the accurate position limitation and sticking by directly using the sticking film, for example, as is disclosed by a certain applicant in CN209508125U entitled a cell phone protective film, and the CN211035784U entitled a cell phone protective film, a protective film for cell phones containing a positioning film is disclosed. The positioning film has a certain adhesiveness and can be stuck on a cell phone screen to play a certain position-limiting role, and then the film sticking operation is carried out, the above two products enjoy the convenience without the use of the film sticking device. The applicant submitted a new utility model patent with the publication number of CN211946896U entitled as a cell phone film later, which is upgraded on the basis of the above two patents. The bottom of the protective film is extended and provided with three positioning film holes. The positioning device of the cell phone is used to position and limit the protective film through the positioning film holes, at the same time, the upper and lower limit positions are combined with the use of the positioning film, which greatly improves the accuracy of alignment. However, the above-mentioned products still have two defects: firstly, the above-mentioned three products are all provided with a fracture in the middle of the release film and the positioning film, which facilitates the separation of the release film into the upper and lower parts to attach films to the upper and lower parts of the screen respectively, but the glue on the side of the protective film body facing the release film and the positioning film penetrates into the surface of the cell phone screen through the fracture, thus leaving a glue mark that is difficult to eliminate on the cell phone screen, greatly reducing the aesthetics of the cell phone screen. Secondly, the third product mentioned above needs to be used with a cell phone film sticking positioning device, wherein the cell phone film sticking positioning device is provided with three protrusions corresponding to the three positioning film holes through the bottom of the protective film, so as to align the protective film, although the accuracy of alignment is improved, the positioning device undoubtedly increases the cost of the product and basically it is also a disposable item, and it will also cause environmental pollution problems if discarded after being used. Therefore, it is necessary to upgrade and improve the above products.

### SUMMARY

Therefore, an object of the present disclosure is to provide a convenient protective film for a cell phone which can realize simple and quick operation for sticking film to solve the problem of fussy sticking film, inaccurate positioning, glue seepage and the like existing protective film for electronic products.

In order to achieve the above purpose, the technical scheme adopted by the disclosure is that a convenient protective film for a cell phone, including: a protective film, a sticking film body, a release film, and a positioning film for positioning with the cell phone from top to bottom sequentially, wherein the bottom edge of the protective film is flush with the bottom edge of the sticking film body and the release film, the middle part of the protective film extends outward along the plane of the protective film to form a protruding portion, the protruding portion is provided with a positioning hole, when the protruding portion is folded 90 degrees toward the direction of the sticking film body, the position and the size of the positioning hole are corresponding to the position and the size of the data line interface of the cell phone, and the data line of the cell phone is inserted into the data line interface of the cell phone through the positioning hole, so that the convenient protective film and the cell phone are accurately aligned and limited.

The technical scheme for realizing the purpose of the disclosure further includes that the release film is divided into a first release film and a second release film by laser cutting line, the first release film and the second release film are connected together in an unused state, in the process of film sticking, the release film is manually broken into upper and lower parts from the laser cutting line.

Alternatively, the position and the size of the positioning hole are corresponding to the position and the size of the earphone interface of the cell phone, and the earphone line of the cell phone is inserted into the earphone interface of the cell phone through the positioning hole, so as to accurately align and limit the protective film with the cell phone.

In addition, the position and the size of the positioning hole are corresponding to the position and size of the charging port of the cell phone, and the charging line of the cell phone is inserted into the charging interface of the cell phone through the positioning hole, so as to accurately align and limit the protective film with the cell phone.

The beneficial effects of the disclosure are that:

1. in the disclosure, the data line is inserted into the data line interface of the cell phone through the positioning hole to perform position alignment and limit, instead of the mode of the cell phone sticking film positioning device in the prior art, due to the fact that the data line, the earphone or the charge line of the cell phone are all base configuration, the present materials can be used for auxiliary completion without adding other auxiliary materials, which reduces the use cost and is more green and environmentally friendly;

2. the release film of the disclosure is divided into a first release film and a second release film by laser, and the first release film and the second release film are connected together in an used state, and in the process of film sticking, the release film is manually broken into upper and lower parts from the laser cutting line, thus ensuring that the adhesive on the lower surface of the sticking film body will not penetrate into the surface of the cell phone screen through the gap between the first release film and the second release film, so that the cell phone screen after sticking the film is cleaner and more beautiful.

### BRIEF DESCRIPTION OF THE DRAWINGS

FIG. 1 is a structural diagram of the protective film of the present disclosure;

FIG. 2 is a structural diagram of the sticking film body of the present disclosure;

FIG. 3 is a structural diagram of the release film of the present disclosure;

FIG. 4 is a structural diagram of the protective film of the present disclosure;

FIG. 5 is a sectional structural diagram of the present disclosure.

FIG. 6 is a schematic view showing that the data line of the cell phone is inserted into the data line interface of the mobile phone through the positioning hole so that the protective film and the cell phone are precisely aligned and restrained at the bottom.

### DETAILED DESCRIPTION OF THE EMBODIMENTS

In order to make the purpose, the technical scheme and the advantages of the embodiment of the disclosure clearer, the technical scheme in the embodiment of the disclosure will be clearly and completely described below with reference to the drawings in the embodiment of the disclosure, obviously, the described embodiment is a part of the embodiment of the disclosure, not all the embodiments. Based on the embodiments in this disclosure, all other embodiments obtained by ordinary technicians in this field without creative work are within the scope of protection of this disclosure.

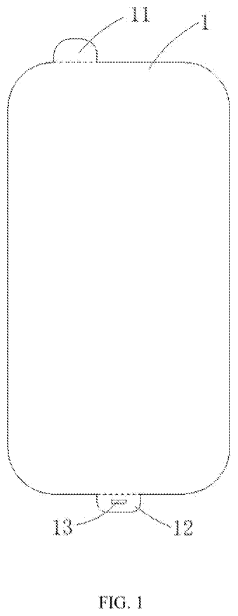

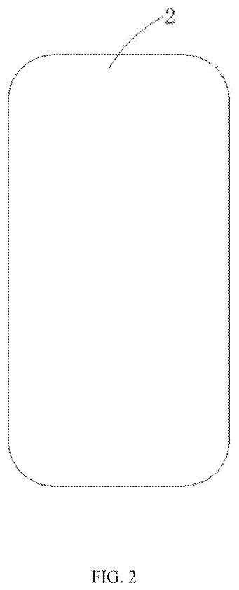

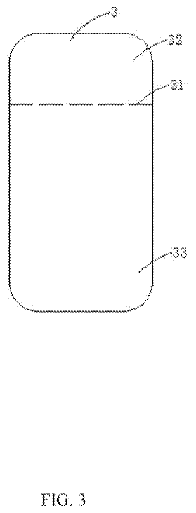

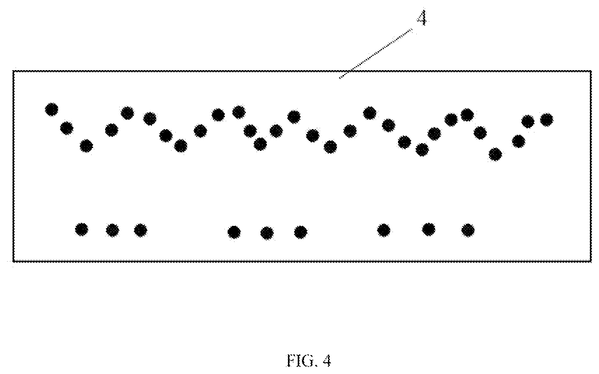

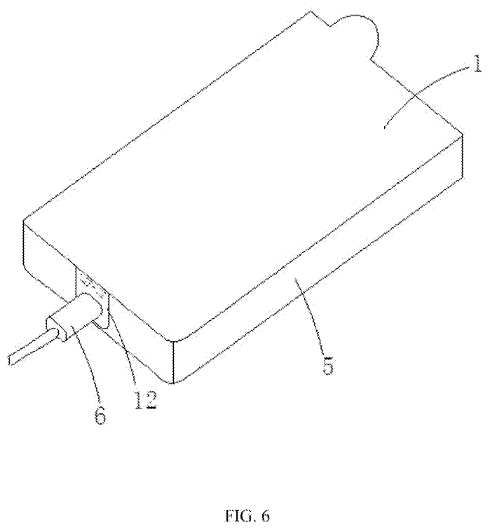

As shown in FIGS. 1-4 and FIG. 6, the convenient protective film for cell phones according to the present disclosure includes a protective film, a sticking film body, a release film, and a positioning film for positioning with the cell phone from top to bottom sequentially. The bottom edge of the protective film is flush with the bottom edge of the sticking film body and the release film. The middle part of the protective film extends outward along the plane of the protective film to form a protruding portion. The protruding portion is provided with a positioning hole, when the protruding portion is folded 90 degrees toward the direction of the sticking film body, the position and the size of the positioning hole are corresponding to the position and the size of the data line interface of the cell phone, and the data line of the cell phone is inserted into the data line interface of the cell phone through the positioning hole, so that the convenient protective film and the cell phone are accurately aligned and limited.

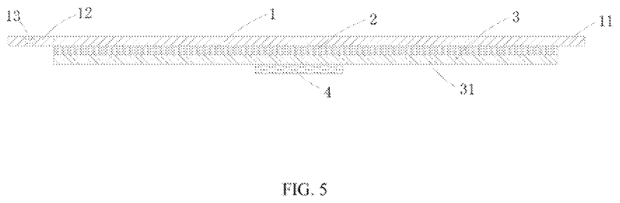

The protective film 1 is arranged on the uppermost layer, the inner surface of the protective film 1 is provided with an adhesive for bonding with the sticking film body 2. The upper portion of the protective film 1 is provided with an uncovering portion 11, and the bottom of the protective film 1 is provided with a protruding portion 12. The protruding portion 12 is provided with a positioning hole 13. The upper surface of the sticking film body 2 is bonded to the inner surface of the protective film 1, and the lower surface of the sticking film body 2 is provided with an adhesive for bonding with the release film 3. After the release film 3 is stripped from the lower surface of the sticking film body 2, the adhesive on the lower surface of the sticking film body 2 can bond and fix the sticking film body 2 to the surface of the cell phone screen. The release film 3 is made of PE or plastic material with a certain hardness, and it is provided with a cutting line 31 penetrating the left and right sides. The cutting line 31 is pre-cut by laser, which divides the release film 3 into a first release film 32 and a second release film 33, and the first release film 32 and the second release film 33 are connected together in an unused state. In the process of film sticking, the release film 3 is manually broken into upper and lower parts from the cutting line 31. The positioning film 4 is strip-shaped, and regularly arranged convex points are arranged on the contact surface between the positioning film 4 and the screen of the cell phone, so that the contact between the positioning film 4 and the screen of the cell phone is multi-point contact, the problem of excessive adhesive force between the positioning film 4 and the screen of the cell phone due to the contact between the positioning film 4 and the screen of the cell phone is avoid, and sufficient adhesive force between the positioning film 4 and the screen of the cell phone is ensured by multi-point contact, so that the adhesion between them is moderated, as shown in FIG. 5.

When the protective film for a cell phone of the disclosure is to be stuck, the data line 6 of the cell phone is firstly inserted into the data line interface of the cell phone through the positioning hole, so that the protective film and the cell phone are accurately aligned and limited at the bottom. Then, the protective film is folded upward, so that the lower surface of the positioning film is attached to the screen surface of the cell phone, and the protective film is aligned with the cell phone in the upper part. Since the protective film has been limited at the bottom by the positioning hole and the data line interface of the cell phone, the possibility of the protective film shifting at the top is very small, and the protective film will shift to the left and right sides of the screen at most, and the positioning film will be lifted up, stick again until accurate alignment is achieved. After alignment, press along the width direction of the positioning film by hand to ensure that the positioning film is stuck on the designated position of the cell phone screen and has certain firmness. Next, the positioning film part is pressed by operator's fingers, the release film is lifted and the release film is turned toward the bottom of the cell phone. The release film is broken into the first release film and the second release film at the cutting line, then the first release film is squeezed and separated from the sticking film body by hand or by using a scraper, and the sticking film body is fixedly stuck on the upper part of the cell phone screen. The data line 6 is then pulled out from the data line interface of the cell phone, and the second release film and the sticking film body are squeezed and separated by hand pressing or using a squeegee according to the same method. When the second release film is completely torn off, the lower part of the sticking film body is also completely attached to the cell phone screen. Finally, the protective film is torn off by the lifting part to complete the whole sticking process.

Similarly, in the above embodiment, the data line 6 is inserted into the data line interface of the cell phone through the positioning hole, or the position and the size of the positioning hole 13 are corresponding to the position and the size of the earphone interface of the cell phone, and the earphone line of the cell phone is inserted into the earphone interface of the cell phone through the positioning hole 13, so as to accurately align and limit the protective film with the cell phone, or the position and the size of the positioning hole 13 are corresponding to the position and size of the charging port of the cell phone, and the charging line of the cell phone is inserted into the charging interface of the cell phone through the positioning hole 13, so as to accurately align and limit the protective film with the cell phone, and other various embodiment structures. Due to the fact that the data line 6, the earphone or the charge line of the cell phone are all base configuration, the present materials can be used for auxiliary completion without adding other auxiliary materials, which reduces the use cost and is more green and environmentally friendly.

What is claimed is:

1. A protective film for cell phones, from top to bottom sequentially, comprising: a protective film, a sticking film body, a release film, and a positioning film for positioning with the cell phone,
wherein the bottom edge of the protective film is flush with bottom edges of the sticking film body and the release film; a protruding portion is provided by extending a middle part of the protective film outward along a plane of the protective film; the protruding portion is provided with a positioning hole;
when the protruding portion is folded 90 degrees with respect to the plane direction of the sticking film body, a position and size of the positioning hole correspond to the position and size of a data line interface of the cell phone to be stuck; and
the positioning hole is configured for accurately aligning and limiting the protective film and the cell phone to be stuck when the data line of the cell phone passes through the positioning hole and is inserted into the data line interface of the cell phone to be stuck.

2. The film of claim 1, wherein the release film includes a first release film and a second release film; the first release film and the second release film are connected together in an unused state; and the release film is manually broken into upper and lower parts from the laser cutting line during film sticking.

3. The film of claim 1, wherein the position and the size of the positioning hole are in correspondence with the position and the size of the earphone interface of the cell phone; and the earphone line of the cell phone is inserted into the earphone interface of the cell phone through the positioning hole for accurately aligning and limiting.

4. The film of claim 1, wherein the position and the size of the positioning hole are in correspondence with the position and size of the charging port of the cell phone, and the charging line of the cell phone is inserted into the charging interface of the cell phone through the positioning hole for accurately aligning and limiting.
